(19) United States
(12) Patent Application Publication
(10) Pub. No.: US 2006/0180548 A1
(43) Pub. Date: Aug. 17, 2006

(54) Liquid depletion in solid phase separation processes

(76) Inventor: Zhenghua Ji, Wilmington, DE (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/060,236

(22) Filed: Feb. 17, 2005

(51) Int. Cl. B01D 61/00

(52) U.S. Cl. 210/649; 210/767; 210/808; 436/177

(57) ABSTRACT

Methods and apparatus are disclosed for depleting liquid in a porous solid phase. The liquid is disposed adjacent a porous solid phase and a controlled flow of a pressurized gas is applied to the disposed liquid sufficient to move the liquid through and substantially deplete the liquid from the porous solid phase wherein the controlled flow controls the rate of gas flow or the volume of gas flow. In some embodiments the porous solid phase is a porous membrane or a particle bed or monolithic support.

### BACKGROUND OF THE INVENTION

Aspects of the invention relate to the depletion of liquid in separation processes such as, for example, sample filtration and sample extraction processes. These processes generally involve a porous solid phase such as, for example, a membrane, a particle bed, and so forth.

Microfiltration and ultrafiltration are widely used in industry as separation techniques to remove impurities and undesired components such as suspended solids from a liquid solution medium. Microfiltration and ultrafiltration involve loading a liquid medium onto a porous solid phase and allowing liquid filtrate to pass through porous solid phase. During the filtration stage, the liquid medium becomes separated, i.e., some portion of the liquid medium passes through the porous solid phase while other moieties are trapped inside the porous solid phase. In some cases, the trapped moieties are undesired components or waste. In other cases, the trapped moieties are components of interest, which may be subjected to further filtration process.

Solid phase separation/extraction processes are often a combination of multi-step filtrations, such as binding, washing and eluting. Such processes generally involve multiple steps of liquid dispensing and liquid depletion for loading liquid sample onto the solid phase, for washing the solid phase and for eluting the solid phase. Depletion of liquid in these processes is important because it affects elution and wash if the liquid depletion is not complete at each step. For example, the yield of extract will be low if residue of liquid on the solid phase is significant.

Means used to deplete liquid in solid phase separation processes include centrifugation and generating pressure differences using either vacuum or positive pressure. Although centrifugation is an effective and simple technique to deplete liquid, the technique suffers from a number of deficiencies. For example, centrifugation is less automated. Furthermore, centrifugation requires balancing liquid amounts at each step. Additionally, the loading of sample filtration devices such as, for example, columns or multi-well plates, into a centrifuge is not a trivial step. In addition, in centrifugal filtration procedures, the optimal centrifugation parameters are not easy to find and to tune up, often resulting in clogging and incomplete filtration. Another problem with centrifugal ultrafiltration is that the concentration device cannot be sealed from the outside environment as an air passage is necessary at the head of the device to stop generating retentive vacuum as filtration progresses. This can also cause unwanted effects.

The use of pressure difference means in liquid depletion can work with a gas medium, e.g., air. It can be automated relatively easily. However, liquid residue from each step of depletion can be significant and in some instances may be 50% or more of liquid loaded on the solid phase because of liquid/solid surface interactions, pore structure of the solid phase, and driving force on the liquid medium. Additionally, the duration of gas pressure application and the amount of gas pressure itself are two important process conditions since they can cause clogs and excessive drying. Clogging of the solid phase can decrease filtration efficiency by blocking access to the pores of the solid phase, making it more difficult for liquid to pass through the pores and decreasing the rate of liquid flow, or flux, through the solid phase. To regain the original flux rate, the driving pressure on the liquid medium must be increased. This is undesirable because the solid phase can be damaged by application of excessive pressure during processing. Increasing driving pressure and resulting gas flow and duration of pressurization can cause excessive drying, affecting either clogging or reaction or solution concentration.

Pressure techniques for liquid depletion are widely used in the applications of solid phase separation such as filtration or extraction with multi-well plates such as, for example, microtiter plates. In such an application, uniformity or synchronization of liquid depletion in all wells becomes a practical issue, which can result in incomplete liquid depletion in some of the wells. If liquid depletion in some of the wells completes early, for example, the pressure difference is reduced and other wells are not pressurized adequately, then liquid depletion in those wells stops.

There is a need, therefore, for effectively carrying out liquid depletion in solid phase separation techniques that avoids some or all of the disadvantages of the currently employed approaches involving pressure difference.

### SUMMARY OF THE INVENTION

Some embodiments of the present invention are directed to methods for depleting liquid in a porous solid phase. The liquid is disposed adjacent a porous solid phase and a controlled flow of a pressurized gas is applied to the disposed liquid sufficient to move the liquid through and substantially deplete the liquid from the porous solid phase wherein the controlled flow controls the rate of gas flow or the volume of gas flow. In some embodiments the porous solid phase is a porous membrane or a particle bed. In some embodiments the gas is clean air or an inert gas.

In some embodiments the controlled flow of gas is achieved by restricting the flow of the gas to regulate the rate of gas flow based on the rate of liquid depletion. In some embodiments the rate of gas flow is substantially equivalent to the quotient of the amount of liquid divided by the time of depletion.

In some embodiments the porous solid phase is in a container such as, for example, a column or a well, which may comprise one or more openings. In some embodiments the porous solid phase is present in wells of a device comprising more than one well and the rate of gas flow is substantially equivalent to the quotient of the amount of liquid divided by the time of depletion wherein the quotient is multiplied by the number of wells of the device. In some embodiments the pressure of the gas is less than about 100 psi.

In some embodiments the controlled flow of the gas is based on introducing a predetermined volume of the gas into a sealed container comprising the porous solid phase. In some embodiments the container is a column or a well. In some embodiments the predetermined volume of gas is larger than the volume of the porous solid phase in the sealed container. In some embodiments the predetermined volume of gas is larger than the volume of the porous solid phase by about 5% to about 200%. In some embodiments the rate of introduction of the gas is controlled to achieve a gas pressure of about 1 to about 15 psi.

In some embodiments the porous solid phase is a porous membrane and the pressure of the gas is greater than the bubble pressure point of the porous membrane. In some embodiments the gas pressure is adjusted to compensate for clogging of pores of the porous solid phase.

Some embodiments of the present invention are directed to apparatus for conducting a solid phase separation of a liquid sample. The apparatus comprises a solid phase disposed in a container and a flow controller for controlling the rate of flow of gas into the container or the volume of gas into the container. In some embodiments of the apparatus, the container is a sealed container and the flow controller comprises means for introducing a predetermined volume of gas into the sealed container. In some embodiments of the apparatus, the solid phase is a membrane or a particle bed. In some embodiments the apparatus comprises a plurality of sealed containers each comprising at least one outlet. In some embodiments the apparatus comprises a plate, such as a multi-well plate. In some embodiments the apparatus comprises a plurality of containers wherein the flow controller comprises a manifold for directing the flow of gas to the plurality of containers.

### BRIEF DESCRIPTION OF THE DRAWINGS

The following figures are included to better illustrate the embodiments of the apparatus and techniques of the present invention. The figures are not to scale and some features may be exaggerated for the purpose of illustrating certain aspects or embodiments of the present invention.

FIG. 1 is a schematic diagram of an embodiment of an apparatus in accordance with one embodiment of the present invention.

FIG. 2 is a schematic diagram of an embodiment of an apparatus in accordance with one embodiment of the present invention.

### DETAILED DESCRIPTION OF SPECIFIC EMBODIMENTS

Methods

As mentioned above, some embodiments of the present invention are directed to methods for depleting liquid in a porous solid phase. The liquid is disposed adjacent a porous solid phase and a controlled flow of a pressurized gas is applied to the disposed liquid sufficient to move the liquid through and substantially deplete the liquid from the porous solid phase.

The porous solid phase may be comprised of any material that has pores that are either naturally occurring or introduced into the solid phase. A pore is a pathway, which functions as the means by which some moieties pass through a solid phase to the exclusion of other moieties. The moiety passing through the pore may be a solute, a particle, a molecule, a portion of liquid (liquid mixture), or any other moiety of such dimension that it is capable of fitting through the pore. A pore may be an opening of a defined size and shape. The shape of the pore may be, for example, cylindrical, tubular, and the like. The cross-sectional shape of a cylindrical pore may be circular, square, oval, rectangular, elliptical, triangular, pentagonal, hexagonal, and the like. Alternatively, a pore may be a torturous path consisting of a series of openings of undefined shape, which allow moieties of only a certain overall size to pass. In some instances such as, for example, reverse osmosis membranes, the pores may only be as small as the interstitial voids between the polymer nodules in a polymer membrane. The cross-sectional dimension of the pores may be from about molecular sieving (greater than about 1 angstrom) size to sub-millimeter (less than about 1 millimeter) size including micron, submicron, amicron and so forth. The cross-sectional dimension of the pores may be about 4 angstroms to about 0.1 millimeter, about 10 angstroms to about 0.01 millimeter, or about 100 angstroms to about 1 micron. The cross-sectional dimension is measured from farthest opposing points on a cross-section of the walls of the pores. For example, for a pore that has a circular cross-section, the dimension is the diameter of the circle. In another example, the pore has a square cross-section and the dimension is measured from opposing corners of the square. The cross-sectional dimensions of a pore may be constant or may vary over the cross-section of the pore from one point to another.

The porous solid phase may comprise discrete solids (particles, fibers, and the like, or combinations thereof) or it may be a monolithic solid form. The discrete solid may be surface porous, i.e., comprising a smaller dimension surface distortion from its main configuration or contour or surface roughness. In a discrete solid format, pores are formed in between surfaces of discrete solids. A monolithic solid form is one piece of solid with many internal micro channels that are interconnected for the most part.

The materials from which the porous solid phase may be fabricated are dependent on the particular environment of use of the porous solid phase, the nature of the liquid and other materials that will be in contact with the porous solid phase, and so forth. The materials may be organic or inorganic, synthetic or natural, or a combination thereof. Materials include polymers, plastics including, e.g., polyesters, polyamides, etc., resins, polysaccharides such as, e.g., cellulose, cellulose esters such as nitrocellulose and the like, silica or silicon-based materials, ceramics, carbon, metals including metal alloys, metal oxides, inorganic glasses, and so forth. Particular plastics finding use include, for example, polyethylene, polypropylene, such as high density polypropylene, polytetrafluoroethylene (PTFE), e.g., TEFLON®, polymethylmethacrylate, polycarbonate, polyethylene terephthalate, polystyrene or styrene copolymers, polyurethanes, polyesters, polycarbonates, polyureas, polyamides, polyethyleneamines, polyarylene sulfides, polysiloxanes, polydimethylsiloxanes, polyimides, polyacetates, poly etheretherketone (PEEK), and the like. Metals include, for example, stainless steel, hastalloy, platinum, gold, silver, titanium, and so forth.

The porous solid phase may be present in one or more containers, the nature of which is related to the nature of the porous solid phase, to form a filtration opening, to hold filtration liquid and so forth. The container is usually non-porous, allowing filtration liquid passing only through the porous solid phase. Suitable containers include, by way of illustration and not limitation, columns such as spin columns, pipette tips, a well or wells in single- or multi-well plates, tubing, flow channel(s) inside an assembly such as a microfluidic device, a sample interface to an instrument such as gas/liquid chromatography/mass spectrometer, and so forth. There may be one or more containers involved in a particular separation depending on the nature of the liquid and the moieties therein, the nature of the porous solid phase, and the like. Multiple containers may be involved in a single container system. A container or a container system involving multiple containers may be sealed to the ambient environment and gas is introduced into the sealed container or sealed container system by means of a port in fluid communication with a source of gas. A suitable manifold may be employed in a sealed container system to distribute gas to multiple porous solid phases with individually separate gas flow. In some embodiments, a single manifold is employed.

In some embodiments the porous solid phase is a porous or permeable membrane. The porous membrane may be composed of any polymeric or inorganic membrane material. Exemplary membrane materials include, by way of illustration and not limitation, polyethylene, polypropylene, Teflon®, also known as polytetrafluoroethlyene, nylon, polyvinylidene fluoride (PVDF), polyethylene sulfone (PES), polysulfone (PS), (e.g., such as BTS membranes available from Pall Life Sciences), polyvinylpyrrolidine (PVP), PS and PVP (e.g., such as MMM membranes, available from Pall Life Sciences), cellulose, glass fiber, silicon carbide (whiskers or fibers), ceramic fiber, composites thereof, and the like. The thickness of the porous membrane depends on a number of factors such as, for example, the nature of the process in which the membrane is employed, e.g., ultrafiltration, microfiltration, nanofiltration, etc., and so forth. In certain embodiments, the porous membrane comprises an asymmetric distribution of pores, e.g., the membrane comprises a first surface and a second surface, wherein the pores on the first surface comprise a different average diameter from pores on the second surface.

In some embodiments, the porous solid phase is a particle bed where the pores are formed by the space between the particles. Usually, the particle bed is contained in a suitable container such as, for example, a column, a cartridge, a tubing, a well of microwell plate, a micro channel in an assembly (e.g., microfluidic device, etc.) and the like. The particulate material may be, for example, silica, silicon-based materials, and so forth. The size of the particles and the dimensions of the particle bed are dependent on the nature of the separation, the nature of the liquid medium, the composition of the liquid containing the moieties to be separated, the nature of the moieties, and so forth. The size of the particles may be about 0.01 microns to about 1000 microns. The dimensions of the particle bed may be from about 0.01 mm to about 500 mm thick and a diameter or equivalent diameter from about 0.01 mm to about 500 mm.

In some embodiments the porous solid phase is a fiber bed such as, for example, elongate bundles of semipermeable polymeric fibers, glass fiber, ceramic fiber such as silicon carbide whiskers or fibers, cellulose, and the like. The composition of the fibers may be, for example, glass, polymer, ceramics, metal or metal oxide whisker, and the like and combinations thereof such as, for example, fiberglass combined with polypropylene, and the like. Specific examples of fiber beds include, for example, hollow fiber membranes, cellulose, paper, and the like. The considerations regarding the dimensions of the fibers and the fiber beds are similar to those discussed above with regard to membranes in general.

In carrying out the methods, a liquid medium is disposed adjacent the porous solid phase. The liquid medium may be aqueous or non-aqueous. An aqueous medium may be solely water or may include from about 0.01 to about 80 or more volume percent of a cosolvent such as an organic solvent, for example, an alcohol, an ether, an amide, and the like. The initial liquid that is applied to the porous solid phase usually contains one or more moieties that are to be separated. Such moieties may be small organic molecules or large organic molecules, inorganic materials such as, e.g., inorganic solutes, particles, and so forth. Subsequent liquid applications may involve additional aliquots of the initial liquid or a wash liquid depending on the nature of the separation technique being employed, the nature of the liquid, the nature of the solid phase, and the like. The wash liquid may be an aqueous or a non-aqueous liquid as discussed above.

The liquid is disposed adjacent the porous solid phase, which usually means that the liquid is placed in contact with all or a portion of a surface of the porous solid phase, which may be referred to as the contact surface. During the method, the liquid passes into and through the porous solid phase and exits at a different surface, which may be referred to as the exiting surface. Usually, the exiting surface lies opposite to the contact surface but need not. One or more of the moieties present in the liquid are retained at the contact surface or in the porous solid phase or both and the liquid passes through the porous solid phase. The liquid that exits the porous solid phase may be free from moieties originally present in the liquid or the liquid may contain one or more of the moieties originally present in the liquid provided the liquid contained more than one moiety.

A controlled flow of pressurized gas is applied to the disposed liquid sufficient to move the liquid through and substantially deplete the liquid from the porous solid phase. By the phrase “substantially deplete” or “substantial depletion” is meant that at least about 70%, at least about 75%, at least about 80%, at least about 85%, at least about 90%, at least about 95%, at least about 98%, at least about 99%, or about 100% of the liquid is removed from the porous solid phase discounting liquid that is retained by the porous solid phase by virtue of the wetting of a dry solid phase. In other words, a dry porous solid phase will uptake a certain amount of liquid in order to wet the dry solid phase. This liquid is generally not depletable under the conditions generally employed for liquid depletion whether in accordance with the present embodiments or techniques known in the art. The phrase “at least about” means that the depletion is equal to or greater than the designated percentage and that the designated percentage may vary by plus or minus one percent.

The supply of gas to be applied to the liquid requires fluid communication between a gas source and the area where the liquid is disposed. Suitable conduits, connections, valves and the like as are known in the art may be employed. The gas may be clean air or an inert gas such as, for example, nitrogen, noble gases, and the like, and mixtures thereof. Noble gases include helium, argon, krypton, xenon, neon, and the like. The noble gases may be used individually or may be mixed with each other or with other inert gases such as, for example, nitrogen, and the like. Clean air means that the air is substantially free from biological contaminants, particulate, moisture, vapor phase of acid/base, organic solvent vapor residue, and so forth. An inert gas may be used to avoid an undesired chemical reaction or compound degradation during a filtration process involving one or more moieties in a liquid or the liquid itself that is subject to such undesired reaction or degradation.

In some embodiments the rate of gas flow is controlled by restricting the flow of the gas to relate the rate of gas flow to the rate of liquid depletion or the amount of liquid applied divided by the time of depletion. In some embodiments the rate of gas flow is substantially equivalent to the rate of liquid depletion. In this way substantial depletion of liquid from the porous solid phase is achieved. The method is repeated for each cycle of liquid that is applied to the porous solid phase. By the phrase “substantially equivalent to the rate of liquid depletion” is meant that the rate of gas flow is within about 5% to about 500%, within about 10% to about 400%, within about 20% to about 300%, within about 50% to about 200%, or within about 75% to about 125%, or within about 90% to 110%, or within about 95% to about 105%, or within about 100% of the rate of the liquid depletion (the quotient of the amount of liquid divided by the time of depletion). For example, if the liquid volume is 1 ml and the desired filtration time is 1 minute, the quotient is 1 ml/min. Thus, the gas flow rate can be, for example, 0.05 ml/min, 0.5 m/min, 1 ml/min, 2 ml/min, 5 ml/min or other such flow rates within the aforementioned ranges.

Any suitable flow controller for controlling the rate of flow of a gas may be employed. Such flow controllers include, by way of illustration and not limitation, adjustable knobs, analog dials, digital setting membranes, displays, flow restriction assemblies, and the like. Flow restrictors such as, for example, diaphragms, gaps, orifices, capillaries, on/off valves, dense porous supports such as, e.g., discs or rods, and the like, may be employed.

In some embodiments flow control includes restriction in a down-stream channel where the gas flow channel is narrowed to restrict flow at ambient pressure. This may be explained more fully as follows: The flow control inlet is connected to the gas venting port of the collection device that collects the flux from a filtration container. The flow controller outlet is open to the ambient environment. The gas flow is set and controlled to allow desired gas flow to ambient, regardless the setting of head gas pressure. In some embodiments, restriction is present in an up-stream channel where the gas flow channel is narrowed to restrict flow, This may be explained more fully as follows: The flow control inlet is connected to the pressurized gas source, and its outlet is connected to the entrance opening of a filtration container. The gas flow is set and controlled to allow desired gas flow to the filtration container, regardless of ambient pressure. Various examples of restriction devices, by way of illustration and not limitation, include a restrictor such as a Mott's dense porous restrictor, a porous ceramic support such as, for example, a disc, rod, etc., and the like, individual valves including, e.g., piezoelectric controls, on/off valves, capillaries, orifices, diaphragms, and so forth.

The pressure of the gas is dependent on the nature of the porous solid phase, such as membrane or particle bed, on the nature of filtration liquid medium including its surface tension with porous solid phase, bubble pressure point, and its viscosity and filtration rate, defined as the quotient of filtration volume over the duration time and so forth. In general the pressure of the gas is less than about 100 pounds per square inch (psi), less than about 90 psi, less than about 80 psi, less than about 70 psi, less than about 60 psi, less than about 50 psi, less than about 40 psi, less than about 30 psi, less than about 20 psi, less than about 15 psi and may be in the range of about 1 psi to about 10 psi, of about 2 psi to about 5 psi.

In some embodiments the pressure of the gas is substantially equivalent to the bubble pressure point of the porous solid phase with liquid present. In some embodiments, the pressure of the gas is higher than the bubble pressure point of the porous solid phase. The “bubble pressure point” is the pressure required to completely deplete liquid inside the porous solid phase. For example, when the porous solid phase is a membrane, the pressure of the pressurized gas is substantially equivalent to or higher than the membrane bubble pressure point, i.e., the pressure to completely deplete liquid inside the membrane. By the phrase of “substantially equivalent to the bubble pressure point” is meant that gas pressure is within about 5% to about 500%, within about 10% to about 400%, within about 20% to about 300%, within about 50% to about 200%, or within about 75% to about 125%, or within about 90% to 110%, or within about 95% to about 105%, or within about 100% of the gas bubble pressure. For example, if the gas bubble pressure is 10 psi, the gas pressure for liquid depletion filtration may be 8 psi, 10 psi, 12 psi, 30 psi, 50 psi, or other value within the aforementioned ranges. By the phrase “higher than the bubble pressure point” is meant that the pressure of the gas is at least about 5% greater, at least about 10% greater, at least about 20% greater, at least about 50% greater, at least about 100% greater, at least about 200% greater, at least about 400% greater than the bubble pressure point and no more than about 500% greater than the bubble pressure point. The phrase “at least about” means that the pressure is equal to or greater than the designated percentage and that the designated percentage may vary by plus or minus ten percent; for example, 5% would mean a range of 4.5 to 5.5%.

In some embodiments the pressure of the gas may be increased during the liquid depletion process in order to overcome clogging of the porous solid phase by one or more of the moieties in the liquid. This is generally referred to a “soft” clogging of a porous solid phase such as a membrane. By the phrase “soft clogging” is meant that one or more of the moieties temporally sticks to the solid support surface and can be removed from the surface by residue liquid inside the pore area using an increase in the pressure of the gas. In this circumstance the pressure of the gas may be increased to the extent to overcome the clogging and increase in pressures beyond that needed should be avoided. The amount of increase in pressure is usually determined on an empirical basis, e.g., an increment-based approach, and is generally an increase of about 5 to about 500% or about 5 to about 100% over the pressure being used up to that point.

Any suitable detector may be employed for detecting clogging of the porous solid phase. Such detectors include, for example, gas flow sensors to the collection device, gas pressure sensors, liquid level detector sensors, weighting devices, visual observation, and the like. The detector is in communication with a pressure valve to control the pressure of the gas. It is important to note that in this circumstance, although there is an increase in the pressure of the gas, the rate of gas flow is still controlled within the parameters discussed above to achieve substantial depletion of liquid from the porous solid phase.

As mentioned above, in some embodiments the porous solid phase is present in a sealed container or multiple porous solid phases are present, each in a sealed container. Usually, a sealed container has at least one port and may have more than one port such as, for example, two ports, three ports, four ports and so forth. The ports may be employed to introduce gas into the sealed container, to remove liquid that has been depleted from the porous solid phase, and so forth. Depending on the function of the port, it may be referred to as an inlet or an outlet. A predetermined volume of gas is introduced into a sealed container comprising the porous solid phase. In some embodiments the predetermined volume of gas is substantially equivalent to or is larger than the volume, usually the working volume, of the porous solid phase in the sealed container. By the phrase “working volume” is meant the liquid volume added to the porous solid phase By the phrase “substantially equivalent to the volume” is meant that the pipette injects a volume of gas that is about 5% to about 500%, about 10% to about 400%, about 20% to about 300%, about 50% to about 200%, or about 75% to about 125%, or about 90% to 110%, or about 95% to about 105%, or about 100% of the liquid volume. In some embodiments the volume of gas is larger by a predetermined percentage than the volume of the porous solid phase by about 5% to about 200%, by about 5% to about 150%, by about 5% to about 100%, by about 5% to about 75%, by about 5% to about 50%, by about 5% to about 25%, by about 10% to about 100%, by about 10% to about 75%, by about 10% to about 50%, or by about 10% to about 25%. In some embodiments of the above, the pressure of the gas is about 1 to about 15 psi, about 1 to about 10 psi, about 1 to about 5 psi, or about 1 to about 3 psi. In the above embodiments the desired gas pressure may be attained by controlling the rate of introduction of the predetermined volume of gas into the sealed container. The rate of introduction of the gas will then depend on the volume of the sealed container, the nature and amount of liquid, and so forth. The gas may be injected into the sealed container using a suitable injector such as, for example, a pipette (manual or automatic), a syringe, a plunger, a squeeze bulb, a solenoid valve, and the like.

The number of wells that may each contain a porous solid phase may be 1 to about 100,000, about 50 to about 50,000, about 100 to about 10,000. In many embodiments the number of wells corresponds to standard microtiter plates, which may have 96 wells or multiples of 8 wells such as, for example, 24 wells, 48 wells and so forth, or multiples of 96 wells such as, for example, 192 wells, 384 wells, 1536 wells, 2304 wells, and so forth.

The dimensions of the wells vary depending on the particular use of the wells. For liquids contemplated in microarray technology, the volume is comparable with, or less than (e.g., about up to 90% less than, about up to 75% less than, or about up to 50% less than, or about up to 25% less than, or a slightly less than) the volume of a standard microtiter plate well. Slightly less than is up to about 10% less than, up to about 5% less than, up to about 3% less than (and so forth) the volume of standard microtiter plate wells. The volume of standard microtiter plate wells is about 2 JIL to about 20,000 gL, about 5 μL to about 1,000 μL, about 10 μL to about 400 μL, about 15 μL to about 350 μL, about 20 μL to about 200 μL. For wells that have a substantially circular cross-sectional dimension, the diameter of the wells is about 50 to about 15,000 microns, about 100 to about 10,000 microns, about 200 to about 7,000 microns and the depth is about 5 to about 10,000 microns, about 50 to about 5000 microns, about 100 to about 1000, about 200 to about 300 microns. Wells having a cross-sectional dimension that is other than circular will have dimensions comparable with the above.

As mentioned above, more than one porous solid phase may be employed in an apparatus. These may take the form, for example, of a multi-well plate wherein each well has a separate porous solid phase. Alternatively, the apparatus may comprise multiple filtration devices such as columns and the like. In some embodiments, a single source of pressurized gas is used together with separate or individual control of gas flow for each of the porous solid phases that are contained in a sealed container. In some embodiments a single manifold is employed to direct pressurized gas flow to each of the porous solid phases. The gas flow to each of the porous solid phases is individually controlled to accomplish liquid depletion from each of the solid phases. Individual flow control is employed to maintain substantially the same gas flow to each porous solid phase with disposed liquid and substantially the same head pressure for each porous solid phase. By the phrase “substantially the same” is meant that the particular parameter referred to above is within about ±25% of each other, about ±20% of each other, about ±15% of each other, about ±10% of each other, about ±5% of each other, about ±3% of each other, about ±2% of each other, about ±1% of each other, or the same. The pressure of the gas should be adjustable so that it may be increased to overcome clogging if it occurs or to compensate for liquid depletion in one or more porous solid phases prior to liquid depletion in the remaining porous solid phases. This may lead to pressure differences arising because gas flow might be preferred through porous solid phases depleted of liquid.

Apparatus

As mentioned above, some embodiments of the present invention are directed to apparatus for conducting a solid phase separation of a liquid sample. The apparatus comprises a solid phase disposed in a container and a flow controller for controlling the rate of flow of gas into the container or the volume of gas into the container. In some embodiments of the apparatus, the container is a sealed container and the flow controller comprises means for introducing a predetermined volume of gas into the sealed container. In some embodiments of the apparatus, the solid phase is a membrane or a particle bed. In some embodiments the apparatus comprises a plurality of sealed containers each comprising at least one outlet such as for example, one outlet, two outlets, three outlets, four outlets, and so forth. In some embodiments the apparatus comprises a plate. In some embodiments the apparatus comprises a plurality of containers wherein the flow controller comprises a manifold for directing the flow of gas to the plurality of containers.

The components of the present apparatus are adapted to perform a specified function usually by a combination of hardware and software. This includes the structure of the particular component and may also include a microprocessor, embedded real-time software and I/O interface electronics to control a sequence of operations and so forth.

Examples of embodiments of the present apparatus are discussed below by way of illustration and not limitation and with reference to the attached drawings.

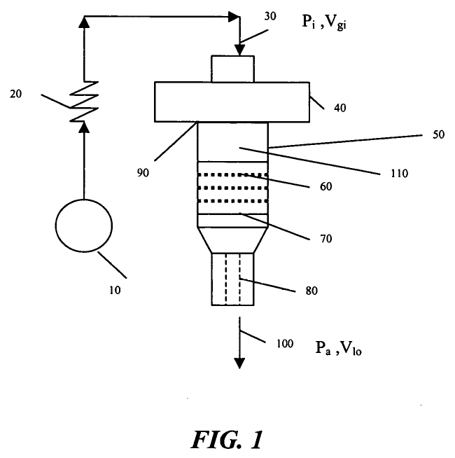

FIG. 1 shows an embodiment of the present invention for single filtration with positive difference ((Pᵢ−Pₐ), and flow restriction (V_{gi} or Vₗₒ) for single filtration container. The apparatus comprises filtration column 50, a filtration holder (not shown), an adaptor 30 40, a pneumatic controller consisting of gas pressure source 10, flow restrictor 20 and gas inlet/connector 30, which is an inlet for pressurized gas with pressure Pi and volume/flow rate V_{gi}. In the embodiment of FIG. 1, the filtration column 50 has two openings or ports 90 and 100 and a container space to hold porous solid material 70, liquid 80 and gas/air 110. Filtration flux out opening 100 is at ambient pressure Pa and flow rate Vₗₒ. Opening 90 is used for loading liquid for filtration including loading, binding, washing, elution, and other processes, as well as the connection interface to adaptor 40. Opening 100 is used for flow channel of the depleting liquid to a collection device (not shown). The porous solid support 70 can be membrane, porous or solid particle bed, weaved fiber, or monolithic porous disc, or other known porous solid support. The porous solid support may include a substrate and lock ring for secure assembling. The substrate can be any porous flit that covers the cross section area at the porous solid support position. The lock ring is placed onto the top of the porous solid support to further secure it. The porous solid support 70 is assembled inside the filtration column 50, usually at or near the bottom of the column housing, but other assembling positions are possible. The porous solid support is fitted tightly into column housing 50 so the depleting liquid only passes through the porous space.

In some embodiments a plural configuration is employed wherein the filtration column (50) can be multi-columns placed onto an integrated holder, or a microwell filtration plate such as, for example, a 96-well filtration plate, or a strip connected array format, or other such embodiments, in a matrix format arrangement.

The pneumatic controller comprises a connection port to a pressurized gas source 10, flow restrictor 20, and gas inlet/connector 30. The flow restrictor 20 can be any known in the art such as, for example, a porous metal disc or cylinder, capillary, orifice, gap or channel including varied opening over time, on/off actuator/valve, and so forth. Flow restrictor 20 will deliver adequate gas flow rate and pressure to the filtration container 50 through the adaptor 40 for a predetermined filtration rate.

Adaptor 40 may be a removable, detachable interface of pressurized gas to filtration column 50 by manual or automatic means during the filtration process. Adaptor 40 fits the opening 90 with gas flow path into 90 and a gas tight seal onto outer surface of 90 by any known technique such as, e.g., O-ring, gasket, softer-material made, or smooth machined contacting surface, or the like. Adaptor 40 also is connected to gas inlet 30 with gas tight seal. In a plural format, adaptor 40 is a multiple outlet manifold with separated individual flow path and connection interface to plural filtration columns 50, i.e., the gas flows in its own channel and does not flow to other channels to other filtration column 50.

During the filtration process, column 50 is held onto a holder for the housing (not shown) such as a support with cavity to house the column outer body with opening 100 to a liquid collection device (not shown), and opening 90 for liquid loading and connection to the gas adaptor 40. First, the filtration liquid (solution containing moieties of interest, wash liquid, elution liquid) is loaded into column 50. In most cases, the liquid only occupies a partial volume of the container 50, leaving some space for gas/air, although full filling of the column is possible. After completion of the liquid loading, the adaptor connecting to pneumatic controller is gas-tight sealed and attached to the column at opening 90 by manual or automatic means. The gas flow is either predetermined or adjusted or controlled during the process to be substantially equivalent to a predetermined filtration rate (defined as the quotient of amount of liquid divided by the time of depletion). The gas pressure is controlled/adjusted to obtain a gas pressure substantially equivalent to the gas-bubble pressure of the porous solid support with filtration liquid present.

After completion of liquid depletion, the gas supply is shut off, and the adaptor is removed from the opening 90, allowing a next filtration step to be carried out with repeatable or similar process and condition used for same or different type of liquid depletion.

In some instances, the filtration is not completed mostly caused by clogging or membrane fouling. As mentioned above, in such a circumstance the gas pressure may be increased but still with equivalent gas flow rate to the filtration column 50. The increase in gas pressure is sufficient to break the clogging. This approach is particularly suited for a plural filtration format is used. In plural filtration format, some filtrations may complete where others have not. With flow restriction and equivalent gas flow rate in each filtration column/well, gas pressure increase is equal for all filtration column/wells. Clogging is overcome and the filtration process is completed. For example, in a 96-well plate filtration, the initial gas pressure is 5 psi. If clogging occurs inside one of the wells, the gas pressure is increased to 30 psi to break the clogging in the clogged well while gas flow is maintained at the restricted/controlled level. The gas pressure increase is realized over all wells.

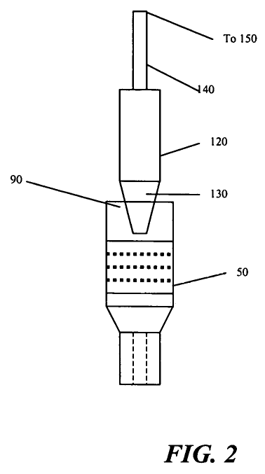

FIG. 2 shows another embodiment of the present invention, namely, an apparatus of liquid depletion of single container with limited gas injection. The apparatus comprises a filtration column 50 as defined in FIG. 1, a pipette tip 120 connects with filtration column 50 at opening 90 with gas tight seal feature 130, a pipette tip holder 140, which connects to an external gas injection device 150, such as, for example, a limited rotation pump, a plunge/syringe, a piezoelectric device, a pressure source/control device with timing open/closed solenoid valve, a closed gas container to generate gas pressure under thermal cycling or enclosure deformation, or the like. In this embodiment, a cycling plunging pipettor is employed in place of the pneumatic controller shown in the apparatus of FIG. 1 to generate gas pressure source and restriction flow. Again, the contact between pipette tip 120 and the opening (90) is a gas tight seal 130, which may be achieved with any known technique such as, for example, O-ring, interference fit of tip to the opening (90), or the like. After the pipettor loads the filtration liquid into the filtration column (50), the pipette uses either a new tip or an old tip to move down into the opening (90) and injects gas/air into the filtration column (50). The amount of gas injected is substantially equivalent to the volume of filtration liquid. In the event that liquid depletion is not completed using a single injection of gas, the process may be repeated to achieve liquid depletion. The injection speed of the pipette can be regulated to be substantially equivalent to the depletion rate, defined as the quotient of amount of liquid depletion divided by the depletion time.

Application of Embodiments

Embodiments of methods and apparatus of the present invention have application to any method or system in which a liquid medium comprising one or more moieties is passed through a porous solid phase. Some embodiments of the invention may be applied to apparatus and methods involving liquid depletion from a porous solid support filtration device. Such methods or systems include extraction techniques, filtration techniques, concentration techniques, purification techniques, separation techniques, desalination techniques, and so forth. Examples of extraction techniques include, by way of illustration and not limitation, nucleic acid isolation and purification from biological samples, protein isolation from biological samples, protein/peptide from aqueous solution containing organic solvent and salt, cell culture from culture solution, liquid from a aqueous solution containing salts, organic compounds from aqueous solution, liquid from a solution containing particulates or solid suspensions, and the like. Examples of filtration techniques include, by way of illustration and not limitation, microfiltration, diafiltration, ultrafiltration, nanofiltration, reverse osmosis, and the like. Examples of concentration techniques include, by way of illustration and not limitation, low level of organic compound from an aqueous solution, protein/peptide from a digest solution, labeled DNA/RNA from labeling solution, particulates from a suspension solution, and the like. A filtration device may be a filtration column, micro-filtration column, microwell filtration plate, solid phase extraction column, spin column, micro-centrifuge filtration column, or the like.

Such moieties may be small organic molecules or large organic molecules, inorganic materials such as, e.g., inorganic solutes, particles, sol-gel, precipitants, and so forth. The small organic molecules generally have a molecular weight less than about 2000 and the large organic molecules generally have a molecular weight greater than about 2000. The large organic molecules include polypeptides such as proteins including, e.g., enzymes, antigens, antibodies, membrane proteins, and the like, polysaccharides, polynucleotides such as DNA, RNA, cDNA, cRNA, labeled cDNA/cRNA, and the like.

### EXAMPLES

The invention is demonstrated further by the following illustrative examples. Parts and percentages are by weight unless otherwise indicated. Temperatures are in degrees Centigrade (° C.) unless otherwise specified. The following examples illustrate the invention but are not intended to limit its scope.

The following is an example of positive pressure liquid depletion in accordance with embodiments of the present invention. An apparatus similar to that depicted in FIG. 2 and discussed above was employed. The columns were filtration columns, namely, RNA isolation mini columns, each with a 700 μl working volume (Agilent Technologies Inc., Palo Alto Calif.), and each being initially dry. A HeLa cell culture was lysed to release RNA in accordance with manufacturer's instructions (Agilent Technologies Inc.). The protocol was as follows:

Load 600 μl HeLa cell lyse into column

Wash 2 times with 600 μl wash buffer

Elute 2 times with 30 μl water

All liquid depletion was carried out by introducing about 1 ml of clear air manually within about 1 min. into each column to achieve slow air extrusion into each column. During the course of air extrusion, the pressure difference changed from zero at the start to about 10 psi at the peak, returning to zero at the end of air extrusion. This procedure was carried out 2 times for each step.

The results are shown in Table 1 and Table 2, which respectively show the liquid depletion and residue from each depletion step.

TABLE 1
Table 1 depicts results as a percentage calculated by dividing the
weight of the eluate by the weight of the liquid loaded onto the
column time 100.

| Column | 1 | 2 | 3 | 4 | 5 | 6 |
|---|---|---|---|---|---|---|
| 1^{st} sample load, 600 μl | 88.5 | 87.5 | 86.6 | 89.8 | 86.8 | 87.0 |
| 1^{st} wash, 600 μl | 99.9 | 99.0 | 99.9 | 93.3 | 99.2 | 96.5 |
| 2^{nd} wash, 600 μl | 101.1 | 97.9 | 100 | 105.4 | 98.8 | 100 |
| 1^{st} elution, 30 μl | 130.7 | 215.6 | 159.2 | 102.6 | 191.6 | 223.6 |
| 2^{nd} elution, 30 μl | 101.1 | 98.0 | 122.1 | 112.8 | 134.5 | 130.6 |

It is evident from the results of the 1^{st} sample load that a portion of the liquid remains on the dry column because of surface wetting and liquid residue trapped inside non-connective pore area. In the 1^{st} wash and the 2^{nd} wash, approximately 100% of the liquid applied is depleted from the wet column. In the 1^{st} and 2^{nd} elutions, the results indicate that in some instances more than 100% of liquid is depleted because the amount of the liquid applied in the 1^{st} and 2^{nd} elutions is only a fraction of that applied in the 2^{nd} wash and because of the change from mixing and exchanging of washing liquid residue and elution liquid and amount of soluble eluent. Therefore, only a small amount of residual wash liquid in the 1^{st} or 2^{nd} elution liquids will result in an apparent substantial increase in the percentage of liquid depleted over that applied.

TABLE 2
Table 2 depicts results as weight of residues after liquid depletion (mg)

| Column | 1 | 2 | 3 | 4 | 5 | 6 |
|---|---|---|---|---|---|---|
| After 1^{st} load | 64.3 | 66.5 | 72.1 | 52.8 | 69.2 | 69.7 |
| After 1^{st} wash | 0.6 | 5.3 | 0.5 | 33.8 | 37 | 17.3 |
| After 2^{nd} wash | −5.8 | 10.6 | −1.3 | −27.2 | 6 | 0.1 |
| After 1^{st} elution, 30 μl | −7.9 | −31.1 | −15.4 | −0.7 | −16.3 | −27.7 |
| After 2^{nd} elution, 30 μl | −0.3 | 0.8 | −6.5 | −4.6 | −9.5 | −7.5 |

The reasons for negative amounts in some instances are the reasons expressed above for the results as percentages.

All publications and patent applications cited in this specification are herein incorporated by reference as if each individual publication or patent application where specifically and individually indicated to be incorporated by reference.

Although embodiments of the foregoing invention have been described in some detail by way of illustration and example for purposes of clarity of understanding, it will be readily apparent to those of ordinary skill in the art in light of the teachings of this invention that changes and modifications may be made thereto without departing from the spirit or scope of the appended claims. Furthermore, the foregoing description, for purposes of explanation, used specific nomenclature to provide a thorough understanding of the invention. However, it will be appreciated that one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A method for depleting liquid in a porous solid phase, the method comprising:
(a) disposing a liquid adjacent a porous solid phase and
(b) applying to the disposed liquid a controlled flow of a pressurized gas sufficient to move the liquid through and substantially deplete the liquid from the porous solid phase wherein the controlled flow controls the rate of gas flow or the volume of gas flow.

2. A method according to claim 1 wherein the gas is clean air or an inert gas.

3. A method according to claim 2 wherein the controlled flow of gas is achieved by restricting the flow of the gas to regulate the rate of gas flow based on the rate of liquid depletion.

4. A method according to claim 3 wherein the rate of gas flow is substantially equivalent to the quotient of the amount of liquid divided by the time of depletion.

5. A method according to claim 4 wherein the porous solid phase is present in wells of a device comprising more than one well and the rate of gas flow is substantially equivalent to the quotient of the amount of liquid divided by the time of depletion wherein the quotient is multiplied by the number of wells of the device.

6. A method according to claim 4 wherein the pressure of the gas is less than about 150 psi.

7. A method according to claim 1 wherein the controlled flow of the gas is based on introducing a predetermined volume of the gas into a sealed container comprising the porous solid phase.

8. A method according to claim 7 wherein the container is a column or a well.

9. A method according to claim 7 wherein the predetermined volume of gas is larger than the volume of the porous solid phase in the sealed container

10. A method according to claim 9 wherein the predetermined volume of gas is larger than the volume of the porous solid phase by about 5% to about 200%.

11. A method according to claim 10 wherein the pressure of the gas is about 1 to about 15 psi.

12. A method according to claim 1 wherein the porous solid phase is a porous membrane or a particle bed or a monolithic support.

13. A method according to claim 1 wherein the porous solid phase is a porous membrane and the pressure of the gas is greater than the bubble pressure point of the porous membrane

14. A method according to claim 1 wherein the gas pressure is adjusted to compensate for clogging of pores of the porous solid phase.

15. An apparatus for conducting a solid phase separation of a liquid sample, said apparatus comprising:
(a) a solid phase disposed in a container and
(b) a flow controller adapted to control the rate of flow of gas into the container or the volume of gas into the container.

16. An apparatus according to claim 15 wherein the container is a sealed container and the flow controller comprises means for introducing a predetermined volume of gas into the sealed container.

17. An apparatus according to claim 15 wherein the solid phase is a membrane or a particle bed or a monolithic support.

18. An apparatus according to claim 16 comprising a plurality of sealed containers each comprising at least one outlet.

19. An apparatus according to claim 18 wherein said apparatus comprises a microtiter well plate.

20. An apparatus according to claim 15 comprising a plurality of containers wherein the flow controller comprises a manifold.
